(19) United States
(12) Patent Application Publication
(10) Pub. No.: US 2016/0239470 A1
(43) Pub. Date: Aug. 18, 2016

(54) CONTEXT SENSITIVE INPUT TOOLS

(71) Applicant: Google Inc., Mountain View, CA (US)

(72) Inventors: Chi ZHANG, Beijing (CN); Haicheng SUN, Beijing (CN); Yuanbo ZHANG, Beijing (CN); Fan YANG, Beijing (CN); Zhe SU, Beijing (CN); Noah Bart COCCARO, Mountain View, CA (US); Xiangye XIAO, Beijing (CN)

(73) Assignee: Google Inc., Mountain View, CA (US)

(21) Appl. No.: 15/024,610

(22) PCT Filed: Sep. 26, 2013
(86) PCT No.: PCT/CN2013/084289

§ 371 Date: Mar. 24, 2016

(51) Int. Cl. G06F 17/24; G06F 3/0482; G06F 3/0484; G06F 17/27

(52) U.S. Cl. CPC G06F 17/24; G06F 17/2785; G06F 3/0482; G06F 17/275; G06F 17/276; G06F 17/2735; G06F 3/04842; G06F 17/273

(57) ABSTRACT

A computer-implemented method can include receiving an input from a user. The input can include one or more characters in a first script representative of text in a particular language. The input can be received in association with a document. The method can include determining a context of the input based on one or more semantic topics of the document associated with the input. One or more candidates for the input can be determined based on (i) the input, (ii) the context of the input, and (iii) a language model. The candidates can include one or more characters in a second script representative of the text in the particular language. The language model can express a probability of occurrence of the one or more candidates in the particular language. The method can further include outputting a list of the one or more candidates for display to the user.

### FIELD

The present disclosure relates to text input to computing devices and, more particularly, to techniques for utilizing the context of an input to assist a user that is inputting text to a computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user may provide a text input to a computing device by interacting with one or more peripherals, such as a keyboard, keypad or touch display. In some instances, a user may utilize an Input Method Editor (“IME”) that receives text in a first script and a representation of the text in a second script. For example only, a user may wish to input Chinese text in Hanzi characters through the use of a Latin or Roman keyboard, e.g., by entering a Pinyin representation of the text. Alternatively or in addition, a computing device may facilitate text input from a user by suggesting candidate words or characters in the same script as the text input, which is sometimes referred to as “autocorrect” and/or “autocomplete” functionality. In each of these examples, the computing device attempts to determine what text the user is intending to input. It would be desirable to increase the accuracy and speed of this determination.

### SUMMARY

In some embodiments of the present disclosure, a computer-implemented method is described. The method can include receiving, at a computing device having one or more processors, an input from a user. The input can include one or more characters in a first script representative of text in a particular language. Further, the input can be received in association with a document. The method can also include determining, at the computing device, a context of the input based on one or more semantic topics of the document associated with the input. Additionally, the method can include determining, at the computing device, one or more candidates for the input based on (i) the input, (ii) the context of the input, and (iii) a language model. The candidates can include one or more characters in a second script representative of the text in the particular language. The language model can express a probability of occurrence of the one or more candidates in the particular language. The method can further include outputting, from the computing device, a list of the one or more candidates for display to the user.

In some embodiments, the context of the input can be determined from text of the document. Additionally, the method can further include determining, at the computing device, a probability for each candidate of the one or more candidates based on the context of the input and the language model. The probability for each particular candidate can be based on a likelihood that the particular candidate is representative of the input in the second script. A ranked order of the one or more candidates can be determined based on the determined probabilities, and the list can be output in the ranked order.

In various embodiments, determining the one or more candidates for the input can include retrieving, at the computing device, a topic-specific dictionary based on the context of the input, and comparing, at the computing device, the input with entries in the topic-specific dictionary. Additionally or alternatively, determining the one or more candidates for the input can include utilizing, at the computing device, the input and the language model to generate (i) the one or more candidates for the input, and (ii) a probability for each candidate of the one or more candidates, and utilizing, at the computing device, the context of the input to adjust the probability for each candidate of the one or more candidates. The probability for each particular candidate can be based on a likelihood that the particular candidate is representative of the input in the second script.

The document can be an email and the context of the input can be determined from previously entered text in the email. Further, the document can be a web page and the context of the input can be determined from text of the web page. In some embodiments, the first and second script can be identical scripts. Additionally, the method can also include receiving, at the computing device, a selection of a particular candidate from the list of one or more candidates, and updating, at the computing device, the context of the input based on the particular candidate selected.

In some embodiments of the present disclosure, a computer system is described. The computer system can include one or more processors and a non-transitory, computer readable medium storing instructions that, when executed by the one or more processors, cause the computer system to perform operations. The operations performed by the computer system can include any one or more of the operations described above in regard to the disclosed computer-implemented method.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a user interacting with an example computing device according to some implementations of the present disclosure;

FIG. 2 is a functional block diagram of the computing device of FIG. 1 according to some implementations of the present disclosure;

FIG. 3 is a functional block diagram of a user interacting with another example computing device according to some implementations of the present disclosure; and

FIG. 4 is a flow diagram of an example technique for assisting a user in providing text input to a computing device according to some implementations of the present disclosure.

### DETAILED DESCRIPTION

A user may input text to a computing device, e.g., in order to draft an email or other electronic message, to interact with a web page (enter a search query, provide a “user comment”), or to compose a newspaper article, book or research paper. In some situations, the computing device can provide assistance to a user that is providing input text.

As mentioned above, an Input Method Editor (“IME”) can provide assistance to a user that wishes to input text in a script that is different from the script provided to the user for selection. For example, a user may utilize a Latin keyboard to input Chinese text in Hanzi characters utilizing a Pinyin IME. Further, the computing device can include autocorrect and/or autocomplete functionality that provides candidates (words/syllables/phrases/etc.) to the user based on an incorrect and/or partial input.

The present disclosure relates to a technique for utilizing the context of the input to assist a user inputting text. The context of the input, as well as a language model, can increase the accuracy and speed of the assistance tools of the computing device in order to determine the text that is intended by the user based on the input.

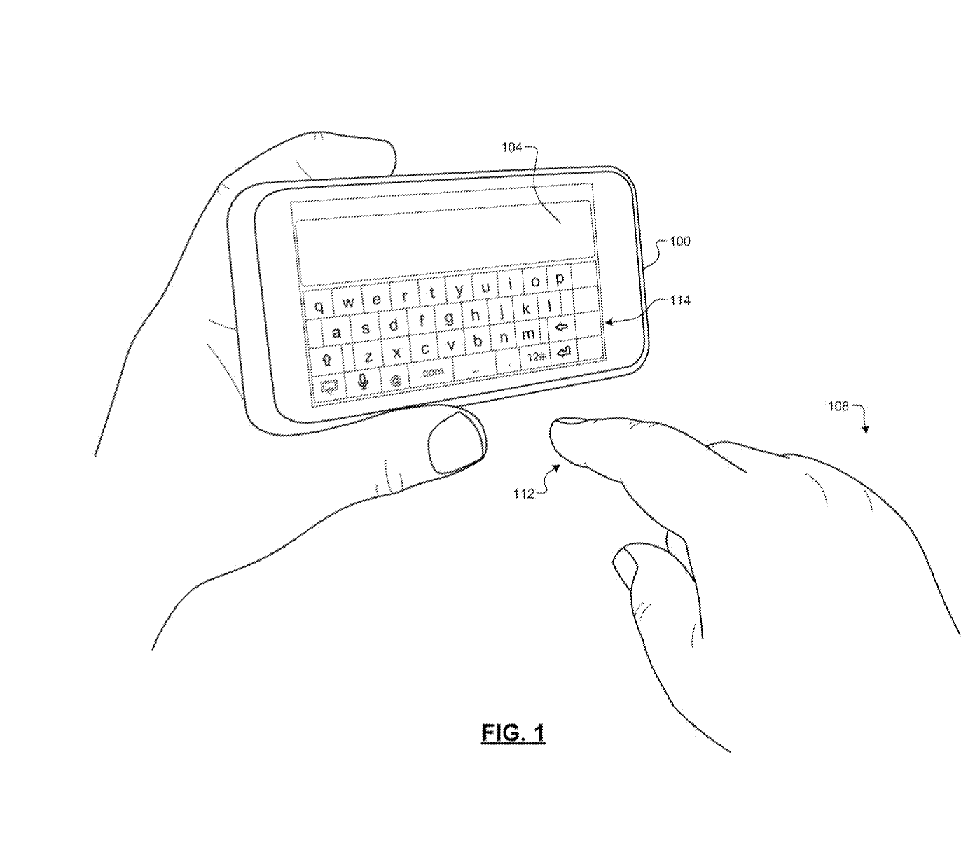

Referring now to FIG. 1, an example computing device 100 is shown. The computing device 100 is illustrated as a mobile device (such as a mobile phone, a tablet computer or “phablet” computer), although it should be appreciated that the term “computing device” can include any form of computer(s) or computer system(s) that include one or more processors for executing instructions. For example only, a computing device can take the form of a desktop computer, a laptop computer, a mobile device (such as a mobile phones, tablets, phablets, and wearable computers), and a server or other distributed computer system, as well as two or more of these example computing devices working together to perform an operation.

The illustrated computing device 100 includes a display 104, such as a touch display as shown. The computing device 100 may additionally or alternatively include a physical keyboard (not shown). The touch display 104 may display information to, and receive input from, a user 108. A “soft” keyboard 114 may be provided on the display 104 through which the user 108 can provide text input. The illustrated keyboard is a Latin keyboard providing Latin alphabet characters, as well as other input options (numbers, a space bar, symbols, etc.). The user 108 may input text to the computing device 100 via the touch display 104 and/or keyboard 114 using one or more fingers 112.

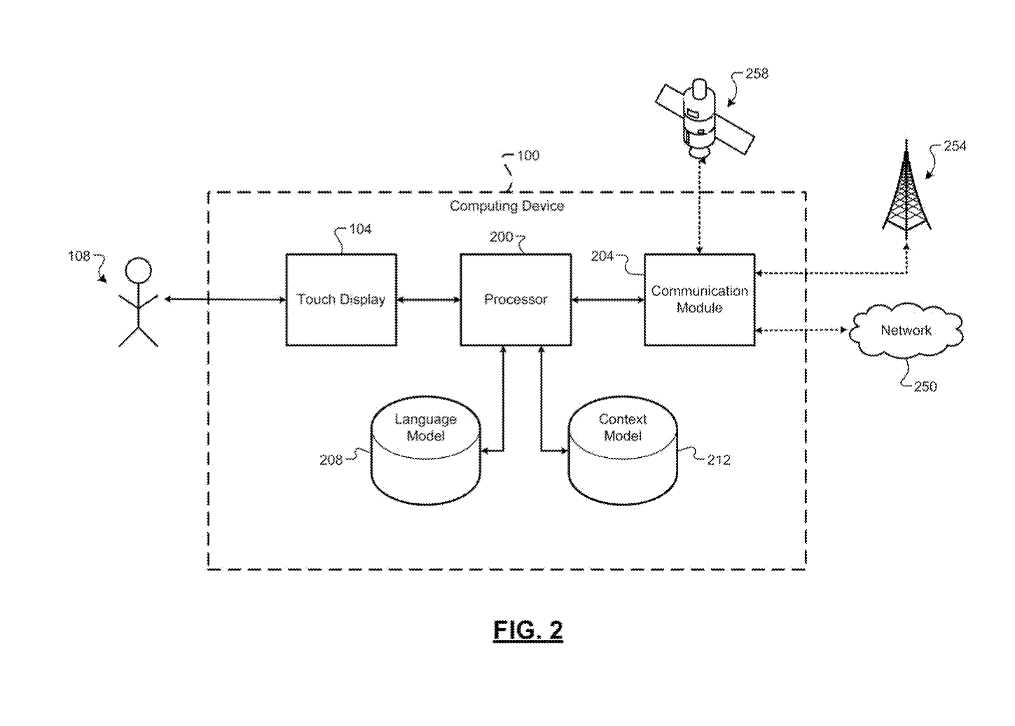

Referring now to FIG. 2, a functional block diagram of the example computing device 100 is shown. The computing device 100 can include a processor 200 and a communication device 204. The term “processor” as used herein refers to both a single processor, as well as two or more processors operating together, e.g., in a parallel or distributed architecture, to perform operations of the computing device 100. The computing device 100 can further include a language model 208 and a context model 212. While shown and described herein as separate components of the computing device 100, one or both of the language model 208 and the context model 212 can be implemented by the processor 200. It should be appreciated that the computing device 100 can include additional computing components that are not illustrated in FIG. 2, such as memory, a microphone, a speaker, one or more buttons and the like.

The processor 200 controls most operations of the computing device 100. For example, the processor 200 may perform tasks such as, but not limited to, loading/controlling the operating system of the computing device 100, loading/configuring communication parameters for the communication device 204, controlling IME parameters, and controlling memory storage/retrieval operations, e.g., for loading of the various parameters. Further, the processor 200 can control communication with the user 108 via the touch display 104 of the computing device 100.

The processor 200 may provide the user 108 with various different character input configurations via the touch display 104. For example, the processor 200 may provide the user 108 with a form of the standard Latin “QWERTY” keyboard as shown. Alternatively, the processor 200 may provide the user 108 with a standard 12-key configuration, also known as a T9-input based character configuration, or other keyboard configuration.

The processor 200 may receive input from the user 108, e.g., via the provided character input configuration. The processor 200, however, may also provide various IMEs, e.g., a Pinyin IME, which allow the user 108 to input text to the computing device 100 in a first script to obtain text in a different script. The processor 200, therefore, may also convert the input received from the user 108 to one or more desired scripts, e.g., Chinese Hanzi, by converting the user text input in a different script, e.g., in Pinyin. For example, the processor 200 may use the language model 208, in conjunction with a context model 212, when interpreting the user text input (described in detail below).

The communication device 204 controls communication between the computing device 100 and other devices/networks. For example only, the communication device 204 may provide for communication between the computing device 100 and other computing devices associated and/or the Internet. The computing device 100 may typically communicate via one or more of three communication mediums: a computing network 250, e.g., the Internet (hereinafter “the network 250”), a mobile telephone network 254, and a satellite network 258. Other communication mediums may also be implemented. For example, the communication device 204 may be configured for both wired and wireless network connections, e.g., radio frequency (RF) communication.

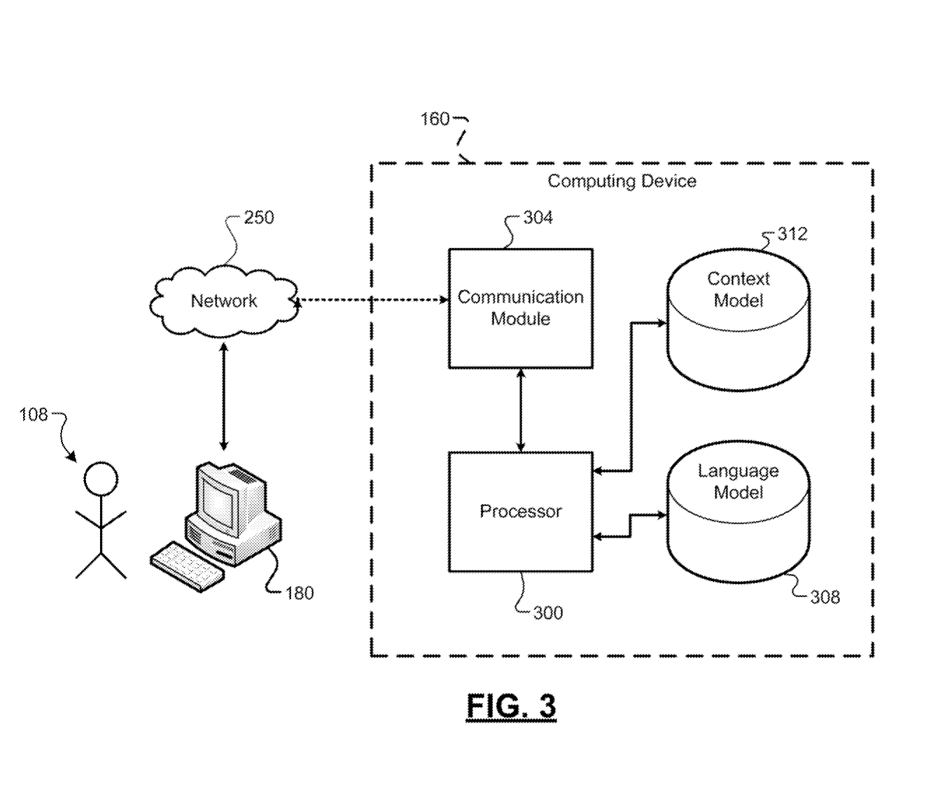

Referring now to FIG. 3, another example computing device 160 for providing context sensitive input tools to a user 108 is illustrated. The computing device 160 is in communication with a computing device 180 of the user 108 via the network 250 (such as the Internet). The computing device 180 is illustrated as a desktop computer, but it should be appreciated that the computing device 180 could be any computer or computer system, such as the computing device 100 illustrated in FIGS. 1-2. Additionally, the computing device 160 will be described in the context of operating as a server, but the computing device 160 can also be any other type of computer or computer system.

Similar to the computing device 100 described above, the computing device 160 can include a processor 300 and a communication device 304, which can operate in a manner similar to the processor 200 and the communication device 204, respectively, described above. The computing device 160 can further include a language model 308 and a context model 312, which can operate in a manner similar to the language model 308 and a context model 312, respectively, described above. Further, it should be appreciated that, while shown and described herein as separate components of the computing device 160, one or both of the language model 308 and the context model 312 can be implemented by the processor 300. The computing device 160 can communicate with the computing device 180 of the user 108 via the network 250.

The techniques described herein can be performed by any of the computing devices 100, 160, 180 working alone or in conjunction with one another. For the sake of simplicity, however, the description below will primarily refer to various operations of the computing device 100. It should be appreciated that the operations can be performed by one or more specific components of the computing device 100 (such as the processor 200 or the communication device 204), the computing device 160 or 180 and/or specific components thereof, or a combination of these elements.

As mentioned above, the user 108 can provide input to the computing device 100 via any one or more input devices, such as the display 104, the soft keyboard 114, a physical keyboard (not shown), or a microphone (not shown). The input can be a keyboard entry, a handwritten stroke or strokes (for handwriting-to-text functionality), or a voice input (for speech-to-text functionality), although other forms of inputs could be utilized. The input can include one or more characters (or portions of a character) in a first script representative of text in a particular language. For example only, in the case of a Pinyin IME, the user 108 can provide text input in Latin script that is representative of text in the Chinese language.

The computing device 100 can receive the input from the user 108 directly (from the user 108 interacting with the computing device 100) or indirectly (e.g., the computing device 160 can receive the input from the user 108 via another computing device 100, 180). The input can be received in association with a document. A document can be any textual record to which the input is to be added, including, but not limited to, an email or other electronic message, a web page, and a document being created/edited by the user 108. Other types of documents include, e.g., an email string to which the user 108 is replying, and one or more previous electronic messages that have been sent to or received from the intended recipient of the electronic message being created by the user 108.

In order to provide text input assistance, the computing device 100 can determine the context of the input, e.g., based on one or more semantic topics of the document associated with the input. An input of text to a document can be expected to be at least somewhat related to the semantic meaning or topic(s) of the document. Thus, the context of the input may be selectively utilized as a signal to assist in determining one or more candidates (characters, words, phrases, etc.) for the input. For example only, if a document is describing a war or a battle of armies and a user 108 provides the input text “piece,” it may be advantageous to provide the word “peace” as a candidate option for the user 108. In this example, the candidate “peace” is an example of autocorrect functionality as it is a spelling correction of the “piece” input of the user 108.

The use of the context of the input as described herein is distinct from the utilization of a language model 208, 308. A language model 208, 308 can express a probability of occurrence of one or more tokens (e.g., words) in a particular language. For example, a language model 208, 308 can describe the probability of a specific token appearing after a given sequence of previously input tokens. Language models are typically described in relation to n-grams, which refer to the probability of a particular token based on the previous (n-1) tokens (n=1 is a unigram model, n=2 is a bigram model, etc.). In contrast to a language model 208, 308, a context model 212, 312 can be utilized to describe longer distance relations between tokens. For example only, referring to the example of “war” and “piece/peace” above, if the token “war” is outside of the previous n tokens in the document, an n-gram language model 208, 308 will not capture any relation between “war” and “piece/peace” as described. A context model 212, 312 that is utilized to determine the context of the input (e.g., one or more semantic topics of the document associated with the input), however, may be able to capture such a relation between “war” and “piece/peace” if these tokens relate to the same semantic topic(s).

As mentioned above, the context of the input can be determined based on one or more semantic topics of the document associated with the input. The semantic topics are a set of topics or concepts related to the text (words, phrases, etc.) of the document. A semantic analysis of the text of a document can be performed to extract the semantic topics.

In some embodiments of the present disclosure, the semantic topics can be extracted from the document by performing Latent Semantic Analysis, Latent Dirichlet Allocation, Replicated Softmax Model, Deep Boltzmann Machine, or a combination of these (or other) techniques. Additionally or alternatively, for a document that is a web page, the semantic topics could be extracted based on keywords associated with the web page. For other types of documents, the semantic topics can be based on the text that has already been entered by the user preceding the current input. It should be appreciated that other techniques for determining the context of the input may be utilized in addition, or as an alternative, to the techniques described above.

A context model 212 can be created and utilized by the computing device 100 to determine the context of the input. For example only, the context model 212 can be generated by a supervised machine learning algorithm that utilizes labeled training data to infer a relationship between documents and semantic topics. Alternatively, the context model 212 can be generated by an unsupervised machine learning algorithm, a semi-supervised machine learning algorithm, or a combination of all three of these types of algorithms.

In each case, the context model 212 can include a context identifier for each known text element (words, phrases, etc.). The context model 212 further includes a plurality of semantic topics, as well as a score for each known text element in relation to each of the semantic topics. Each of the scores is indicative of the correlation between the text element and its associated semantic topic, e.g., the probability that a particular text element is correlated with a particular semantic topic. The context model 212 can be used to identify the semantic topics, as well as the scores, based on the context identifier(s) of a particular document, as described more fully below.

The context of the input can be determined by identifying the text elements (words, phrases, etc.) of the document associated with the input being received. The context identifier for each of these text elements can be determined from the context model 212. Based on the determined context identifiers, the semantic topics and scores for each of the identified text elements of the document can be determined. The scores can be combined to determine which semantic topic or semantic topics are probable for the document. The context model 212 can determine the probability of occurrence of further text elements (such as the input) based on the correlation between text elements and the determined semantic topics. The probability of occurrence can be utilized in conjunction with the language model 208 to identify probable candidates for the input of the user.

Additionally, the computing device 100 can determine a probability for each candidate of the one or more identified candidates. The probability for a particular candidate can be based on a likelihood that the particular candidate is representative of the input. The probability can be based on the context of the input from the context model 212 and the language model 208.

As described above, both the context model 212 and the language model 208 can provide a probability for a particular candidate. In some embodiments, the individual probabilities from each of the language model 208 and the context model 212 can be combined to determine a combined probability for each of the one or more candidates. The combination of the probabilities from the language model 208 and the context model 212 for a particular candidate can be determined based on the equation:

P(w|history)=P_{langmod}(w|history)^{α}*P_{cntxtmod}(w|history)^{(1-α)}, (1)

where w is the particular candidate, history is the information upon which the candidate is based (e.g., for the language model 208, the history can be the known n-grams, and for the context model 212, the history can be the context of the input), P(w|history) is the combined probability, P_{langmod}(w|history) is the probability from the language model, P_{cntxtmod}(w|history) is the probability from the context model, and α is a parameter determined to provide the best fit to training data. In some embodiments, α is selected to equal 0.3, although other values could be utilized. The combined probability can be utilized, e.g., to determine a ranked order of the one or more candidates.

In some embodiments, the computing device 100 can utilize the input and the language model 208 to generate the one or more candidates for the input and a probability for each of the candidates. The computing device 100 can then utilize context of the input (from the context model 212) to adjust the probability for each of the candidates, e.g., by determining a combined probability for each candidate. In this manner, the context of the input is utilized to assist in the determination of the most probable candidates, rather than assisting in the determination of possible candidates.

In some embodiments, the context of the input can be utilized to retrieve a topic-specific dictionary. A topic-specific dictionary is a listing of text elements (words, phrases, etc.) that are associated with a particular semantic topic. The topic-specific dictionary can include unique words that are not present in the standard language model 208. Upon determining the context of the input, a topic-specific dictionary corresponding to the identified semantic topics of the document can be retrieved. The input can then be compared to the entries of the topic-specific dictionary to determine one or more candidates for the input.

Once the one or more candidates have been determined, the computing device 100 can output a list of the one or more candidates (or a subset of the one or more candidates) for display to the user 108. For the computing device 100 that includes a display 104, the outputting of the list of candidates can include displaying the candidates. For the computing device 160, the outputting of the list of candidates can include providing the list of candidates to another computing device 100, 180 for display by the other computing device 100, 180. In some embodiments, the list of candidates can be output in the ranked order, e.g., determined based on the combined probability described above.

Once the list of candidates is output to the user 108, the user 108 can select a particular candidate as representative of the input intended by the user 108. The computing device 100 can receive the selection of the particular candidate for inclusion in the document. Further, the computing device 100 can update the context of the input based on the particular candidate selected. That is, once the user 108 has selected a particular candidate for inclusion in the document, that particular candidate becomes a portion of the document. The context of the updated document, which now includes the selected candidate, can then be determined and utilized for determining one or more candidates for a further input by the user 108.

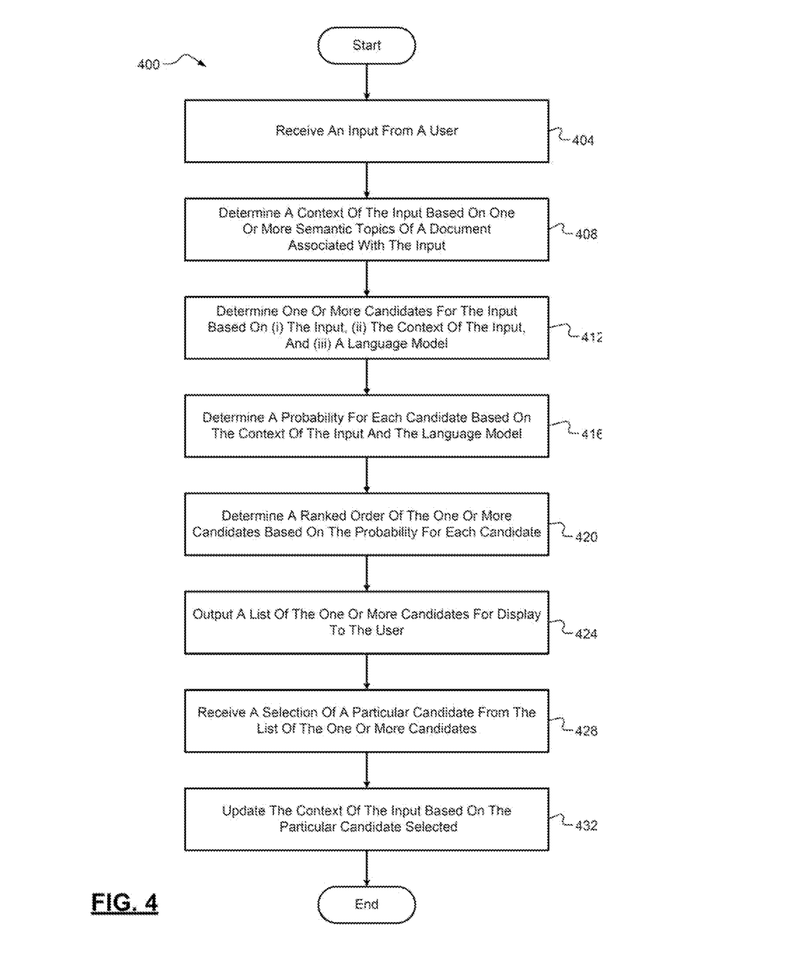

Referring now to FIG. 4, an example technique 400 for assisting a user 108 in providing text input to a computing device 100 is illustrated. While described as being performed by the computing device 100, it should be appreciated that the operations can be performed by one or more specific components of the computing device 100 (such as the processor 200 or the communication device 204), the computing device 160 or 180 and/or specific components thereof, or a combination of these elements. Further, the technique 400 can be implemented by a computer system that includes: (i) one or more processors, and (ii) a non-transitory, computer readable medium storing instructions that, when executed by the one or more processors, cause the computer system to perform the operations of the technique 400.

At 404, the computing device 100 receives an input from the user 108. The input can include one or more characters in a first script that is representative of text in a particular language. Further, the input can be received in association with a document that is being created/edited by the user 108. At 408, the computing device 100 can determine a context of the input based on one or more semantic topics of the document associated with the input. A context model 212 can be utilized to determine the context of the input from the document (e.g., the text of the document) in any of the manners described above.

One or more candidates for the input can be determined at 412. The one or more candidates can be determined based on (i) the input, (ii) the context of the input, and (iii) a language model 208. As described above, the language model 208 can express a probability of occurrence of the one or more candidates in the particular language. The candidates can include one or more characters in a second script representative of the text in the particular language. In the situation where the computing device 100 is providing autocorrect and/or autocomplete functionality, the first and second scripts can be identical. In the situation where the computing device 100 is providing an IME functionality (alone or in combination with autocorrect and/or autocomplete), the first and second scripts can be different. For example only, the user 108 may provide the input in the Latin alphabet to input Chinese text in Hanzi characters utilizing a Pinyin IME.

At 416, a probability for each candidate of the one or more candidates can be determined based on the context of the input (from the context model 212) and the language model 208. A ranked order of the candidates can be determined at 420. The ranked order can be based on the probability for each candidate. At 424, the list of the one or more candidates can be output for display to the user 108. In some embodiments, the list can be output in the ranked order determined at 420. A selection of a particular candidate from the list of the one or more candidates can be received at 428. Based on the particular candidate selected, at 432 the context of the input can be updated. The technique 400 may then end or return to 404 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the terms module or device may refer to, be part of, or include an Application Specific Integrated Circuit (ASIC); an electronic circuit; a combinational logic circuit; a field programmable gate array (FPGA); a processor (shared, dedicated, or group) that executes code, or a process executed by a distributed network of processors and storage in networked clusters or datacenters; other suitable components that provide the described functionality; or a combination of some or all of the above, such as in a system-on-chip. The terms module or device may include memory (shared, dedicated, or group) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), flash memory or any other type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, an input from a user, the input including one or more characters in a first script representative of text in a particular language, the input being received in association with a document;
determining, at the computing device, a context of the input based on one or more semantic topics of the document associated with the input;
determining, at the computing device, one or more candidates for the input based on (i) the input, (ii) the context of the input, and (iii) a language model, the candidates including one or more characters in a second script representative of the text in the particular language, the language model expressing a probability of occurrence of the one or more candidates in the particular language; and
outputting, from the computing device, a list of the one or more candidates for display to the user.

2. The computer-implemented method of claim 1, wherein the context of the input is determined from text of the document.

3. The computer-implemented method of claim 1, further comprising determining, at the computing device, a probability for each candidate of the one or more candidates based on the context of the input and the language model, the probability for each particular candidate being based on a likelihood that the particular candidate is representative of the input in the second script.

4. The computer-implemented method of claim 3, further comprising determining, at the computing device, a ranked order of the one or more candidates based on the determined probabilities, wherein the list is output in the ranked order.

5. The computer-implemented method of claim 1, wherein determining the one or more candidates for the input comprises:
retrieving, at the computing device, a topic-specific dictionary based on the context of the input; and
comparing, at the computing device, the input with entries in the topic-specific dictionary.

6. The computer-implemented method of claim 1, wherein determining the one or more candidates for the input comprises:
utilizing, at the computing device, the input and the language model to generate (i) the one or more candidates for the input, and (ii) a probability for each candidate of the one or more candidates, the probability for each particular candidate being based on a likelihood that the particular candidate is representative of the input in the second script; and
utilizing, at the computing device, the context of the input to adjust the probability for each candidate of the one or more candidates.

7. The computer-implemented method of claim 1, wherein the document is an email and the context of the input is determined from previously entered text in the email.

8. The computer-implemented method of claim 1, wherein the document is a web page and the context of the input is determined from text of the web page.

9. The computer-implemented method of claim 1, wherein the first and second script are identical scripts.

10. The computer-implemented method of claim 1, further comprising:
receiving, at the computing device, a selection of a particular candidate from the list of one or more candidates; and
updating, at the computing device, the context of the input based on the particular candidate selected.

11. A computer system, comprising:
one or more processors; and
a non-transitory, computer readable medium storing instructions that, when executed by the one or more processors, cause the computer system to perform operations comprising:
receiving an input from a user, the input including one or more characters in a first script representative of text in a particular language, the input being received in association with a document;
determining a context of the input based on one or more semantic topics of the document associated with the input;
determining one or more candidates for the input based on (i) the input, (ii) the context of the input, and (iii) a language model, the candidates including one or more characters in a second script representative of the text in the particular language, the language model expressing a probability of occurrence of the one or more candidates in the particular language; and
outputting a list of the one or more candidates for display to the user.

12. The computer system of claim 11, wherein the context of the input is determined from text of the document.

13. The computer system of claim 11, wherein the operations further comprise determining a probability for each candidate of the one or more candidates based on the context of the input and the language model, the probability for each particular candidate being based on a likelihood that the particular candidate is representative of the input in the second script.

14. The computer system of claim 13, wherein the operations further comprise determining a ranked order of the one or more candidates based on the determined probabilities, wherein the list is output in the ranked order.

15. The computer system of claim 11, wherein determining the one or more candidates for the input comprises:
retrieving a topic-specific dictionary based on the context of the input; and
comparing the input with entries in the topic-specific dictionary.

16. The computer system of claim 11, wherein determining the one or more candidates for the input comprises:
utilizing the input and the language model to generate (i) the one or more candidates for the input, and (ii) a probability for each candidate of the one or more candidates, the probability for each particular candidate being based on a likelihood that the particular candidate is representative of the input in the second script; and
utilizing the context of the input to adjust the probability for each candidate of the one or more candidates.

17. The computer system of claim 11, wherein the document is an email and the context of the input is determined from previously entered text in the email.

18. The computer system of claim 11, wherein the document is a web page and the context of the input is determined from text of the web page.

19. The computer system of claim 11, wherein the first and second script are identical scripts.

20. The computer system of claim 11, wherein the operations further comprise:
receiving a selection of a particular candidate from the list of one or more candidates; and
updating the context of the input based on the particular candidate selected.
